(19) United States
(12) Patent Application Publication
(10) Pub. No.: US 2007/0035468 A1
(43) Pub. Date: Feb. 15, 2007

(54) Luneberg lens and antenna apparatus using the same

(76) Inventors: Masatoshi Kuroda, Osaka (JP); Koichi Kimura, Osaka (JP)

Correspondence Address: MCDERMOTT WILL & EMERY LLP, 600 13TH STREET, N.W., WASHINGTON, DC, 20005-3096, US

(21) Appl. No.: 10/566,631

(22) PCT Filed: Jul. 29, 2004
(86) PCT No.: PCT/JP04/10848

§ 371 Date: Sep. 25, 2006

(30) Foreign Application Priority Data
Jul. 31, 2003 (JP) 2003-283437

(51) Int. Cl. H01Q 19/06

(52) U.S. Cl. 343/911 L

(57) ABSTRACT

A luneberg lens, which is configured by combining a plurality of lens parts, has a problem on keeping of a combined condition of lens parts and securement of good moisture prevention, and displacement of lens parts not only becomes a cause of cost-up but also has a bad influence on an electric performance, and furthermore, intrusion of moisture and humidity deteriorates an electric performance, and therefore, these problems are solved by a simple and inexpensive method.

A lens portion 2, which is configured by combining lens parts of spherical core and spherical shell-like resin foams, is configured by a luneberg lens which is sealed by a synthetic resin film 3 which is formed along a surface of that lens portion 2 and in which a thickness is 100 μm or less and of which own relative dielectric constant is higher than a relative dielectric constant of the outermost layer of the above-mentioned lens portion.

### TECHNICAL FIELD

This invention relates to a luneberg lens for transmitting and receiving radio waves to and from a broadcasting and communication satellite etc. and an antenna apparatus using the same.

### BACKGROUND ART

A luneberg lens, which is such a radio wave lens that a sphere formed by a dielectric material is a fundamental form and which is designed in such a manner that a relative dielectric constant εr of each portion of a lens roughly follows a formula of εr=2−(r/R)² assuming that a radius of the sphere is R and a distance from a center of the sphere is r, is known as a multi corresponding radio wave lens by which it is possible to communicate with a plurality of other parties at the same time.

In the meantime, as prior art of this luneberg lens, there are things shown in the following patent documents 1 through 3, and so on, but these documents do not have a description with regard to handling and moisture prevention of a lens.

Patent Document 1: Unexamined Japanese Patent Application Publication No. Sho50-116259

Patent Document 2: Unexamined Japanese Patent Application Publication No. Hei7-22834

Patent Document 3: Examined Japanese Utility Model Application Publication No.Sho55-6177

The luneberg lens is configured, as shown in the patent document 1, in such a manner that a plurality of lens parts (one sphere core and a plurality of sphere shells) with different relative dielectric constants are combined so as to form a multilayer structure, but for example, in case of a hemispheric shaped lens in which radio wave reflecting plates (hereinafter, simply referred to as reflecting plates) are combined to make up a condition equivalent to a sphere, it is necessary to make a lens surface, which is jointed to a reflecting plate, smooth (flat), but during a period before an antenna is formed by combining a lens and a reflecting plate etc., there is such a case that misalignment occurs at relative positions of assembled lens parts to cause concavity and convexity which deteriorate an electric performance of a lens and junction stability with a reflecting plate, at a joint surface with a reflecting plate. In addition, in case of a large size lens, there is such a case that a center sphere core and peripheral sphere shells are configured by combining a plurality of divided parts, and in this case, there is such a case that parts are not lined up to cause a gap which deteriorates an electric performance of a lens, at part fit-in portions of a sphere core and sphere shells.

As to this defect, its occurrence rate is further heightened in case that a luneberg lens is moved to another factory after it is molded and assembled and it is built in a structure of an antenna, since a process of transport etc. is interposed in midstream. When this problem occurs, it becomes necessary to carry out processing for smoothing a joint surface and a correction of misalignment for eliminating a gap between parts, and it invites cost increase.

In addition, in case that a luneberg lens is configured by a bead foam molded body, there is such a case that a singular or a plurality of beads are dropped out during a period of an assembling work as an antenna, a period of transport of lenses, and so on, and an electric characteristic is lowered.

On one hand, in order to eliminate the problem of displacement of lens parts, for example, a method of fixing an interlayer of lens parts by an adhesive agent has been considered, but in this method, there occurs reflections repeatedly at the time of radio wave transmission, since an adhesive agent layer with relative dielectric constant of 2 or more is formed between respective lens parts with relative dielectric constant of 2 or less, and an electric characteristic of a lens is lowered substantially, and in addition, a process increases substantially, and therefore, cost increase is caused.

In addition, a conventional antenna and a radio wave reflecting body using a luneberg lens, as shown by the patent documents 1 and 2, is kept weather resistance, impact resistance, and moisture prevention of a lens by covering a surface of a lens with a cover (radome) formed by plastics and a composite material of plastics (FRP etc.), but in order to secure moisture prevention, there is need to apply high performance seal (moisture prevention) processing between a cover (radome) and a flat plate, or between divided surfaces of a cover (radome), across a fairly long distance (e.g., in case of a lens with φ500 mm, it becomes a length of 1.5 m or more), and its labor hour and cost become something to be unignolable.

As to a spherical lens, there happens something to secure weather resistance, impact resistance and moisture prevention by covering entirety with FRP, and spherical FRP coating requires labor hour and cost for production, and it is a problem on producing inexpensive general purpose products. In case of a hemispherical lens, seal processing is further difficult since there is a reflecting plate, and in addition, in case of applying a seal at a boundary surface of a reflecting plate and a cover, it is conceivable that a reflecting plate and a cover become distorted under the influence of strong wind etc., and a seal portion does not function effectively.

It is desirable that a cover for covering and protecting a surface of a lens is thinned as much as possible since there occurs radio wave transmission loss, but in case of a thin cover, a hole such as a pinhole is generated easily. A pinhole is generated easily in a case of a cover made from FRP consisting of a plurality of different materials. In addition, a thin cover is easily transformed by a load due to wind pressure etc., and in case of applying a seal to a reflecting plate etc., a seal function becomes impaired easily.

Furthermore, when it has been used for many years, deterioration due to ultraviolet ray etc. is advanced, and especially in case of a thin cover, there is such a case that a crack is generated in the cover, and it is cracked and damaged when an object, which got blown by stormy wind, knocked up against it, and rain water etc. flow into a lens portion from a generated crack and damaged portion, to significantly lower an electric performance of a lens, which also becomes a problem. As to a luneberg lens which is formed by such a material that resin foam beads are fusion-bonded, when water enters into a gap between surface beads, or an interlayer gap, that water is not removed for a long time and remains, to come into such a condition that an electric performance is lowered significantly over a long period of time.

Meanwhile, in case of a manufactured luneberg lens is transported to another factory and an antenna is build up there, moisture absorption of lens during a period of transport and storage is conceivable, and there is such a possibility that it becomes an antenna in which an electric characteristic is low.

### DISCLOSURE OF THE INVENTION

Problem that the Invention is to Solve

As described above, a conventional luneberg lens has a problem on keeping of a combined condition of lens parts and securement of good moisture prevention. Then, the invention sets up, as a problem, to realize such a matter that keeping of a combined condition of lens parts and securement of good moisture prevention can be carried out by a simple and inexpensive method.

Means for Solving the Problem

In order to solve the above-described problem, the invention provides a luneberg lens includes: a lens which is configured by combining lens parts of spherical core and spherical shell-like resin foams, wherein the lens is sealed by a synthetic resin film which is formed along a surface of the lens and in which a thickness is 100 μm or less and of which own relative dielectric constant is higher than a relative dielectric constant of the outermost layer of the lens.

It is desirable that the synthetic resin film is a thing having a thickness of 50 μm or less. In addition, as to this synthetic resin film, its type is not particularly regarded, but it is desirable that it is a film formed by olefin series resin such as polyethylene, polypropylene and polystyrene, polyolefin series resin such as ethylene-vinyl acetate copolymer (EVA) and ethylene-acrylate copolymer (EEA), polyvinylchloride, polyvinylidene chloride, polyester, and fluorocarbon resin such as polytetrafluoroethylene (PTFE), or their derivatives, or a mixture of 2 kinds or more among them. In addition, it is also all right even if a multi-layer film, in which 2 layers or more of these films are overlapped or these films are laminated each other or these films and another film (e.g., nylon) are laminated, is used.

Furthermore, it is desirable that that synthetic resin film a shrink film (stretch film having heat shrinkability) It is all right even if this synthetic resin film is fusion-bonded with a lens, or separated from a lens.

In addition to this, when a shrink film is used, there is need to dispose minute pores for letting out inside air at the time of heat shrinkage, in a film, and that pores are closed by carrying out fusion-bonding of the same kind film, sealing through the use of a sheet film, after heat shrinkage.

Meanwhile, the invention additionally provides an antenna apparatus including: a hemispherical luneberg lens, a reflecting plate which is attached to a two-divided cross section of a sphere of this lens, a primary feed which is placed at a focal point portion of the lens, and a holding unit of this primary feed, and in which the above-mentioned hemispherical luneberg lens is configured by the above-described luneberg lens of the invention, and an antenna apparatus which has a luneberg lens, of which surface is sealed by a cover made by synthetic resin, a primary feed which is placed at a focal point portion of the lens, and a holding unit of the primary feed, and in which the above-mentioned hemispherical luneberg lens is configured by the above-described luneberg lens of the invention, and the above-mentioned cover has a thickness of 2 mm or less.

Advantage of the Invention

A luneberg lens of the invention is sealed by a synthetic resin film, and can eliminate displacement of parts by keeping an assembled condition of respective lens parts through the use of a tying force due to the synthetic resin film. In addition, flowing of moisture and humidity into an air gap between air bubbles on a surface of a lens, foam beads, and a gap between lens parts is blocked by the synthetic resin film, and therefore, moisture prevention is improved substantially.

Therefore, it becomes possible to build up an antenna easily with keeping a high electric characteristic, and in addition, even in case of carrying out long-term storage and transport before antenna fabrication, it is possible to maintain an electric performance without problems, and it is also possible to obtain advantages of reduction of the number of manufacturing processes, and cost reduction.

In addition, since intrusion of moisture and humidity into an inside of a lens is blocked, it also becomes possible to maintain a good electric characteristic of a lens over a long period of time.

Meanwhile, a film formed by olefin series resin such as polyethylene, polypropylene and polystyrene, polyolefin series resin such as ethylene-vinyl acetate copolymer (EVA) and ethylene-acrylate copolymer (EEA), polyvinylchloride, polyvinylidene chloride, polyester, and fluorocarbon resin such as polytetrafluoroethylene (PTFE), or their derivatives, or a mixture of 2 kinds or more among them, or a multi-layer film, in which 2 layers or more of these films are overlapped or these films are laminated each other or these films and another film (e.g., nylon) are laminated, is of such a thing that both of a humidity transmission factor and a moisture absorption rate are low, and when a lens is sealed by a film formed by these resin, moisture prevention is improved substantially.

In addition, as to such a thing that a lens is sealed by a shrink film, it is possible to easily fit a film on a surface of the lens, and a superfluous film does not exist as wrinkle and wrap, and therefore, it is possible to obtain a lens in which an electric characteristic is extremely good.

In addition to this, in an antenna apparatus of the invention, moisture prevention of a lens is secured by a synthetic resin film, and therefore, even if a cover is cracked and sealing of a boundary surface of a cover and a reflecting plate is insufficient, it is possible to obtain excellent moisture prevention, and it is possible to suppress lowering of an electric performance due to long-term use.

In addition, it also becomes possible to reduce a thickness of a cover, and it also becomes possible to heighten an electric performance of an antenna by reducing radio wave transmission loss due to the cover.

### BRIEF DESCRIPTION OF THE DRAWINGS

[FIG. 1]

FIG. 1 shows a cross sectional view of an antenna apparatus which uses a luneberg lens of the invention.

[FIG. 2]

FIG. 2 shows a detailed view of a cross section of a luneberg lens which is used in the antenna apparatus of FIG. 1.

[FIG. 3]

FIG. 3 shows an explanatory view of a sealing process through the use of a film.

[FIG. 4]

FIG. 4 shows an explanatory view of a sealing process through the use of a film.

### DESCRIPTION OF REFERENCE NUMERALS AND SIGNS

1 luneberg lens
2 lens
2a hemispherical core
2b hemispherical shell
3 sealed layer through the use of a synthetic resin film
4 reflecting plate
5 cover
6 seal
7 arm
8 primary feed
9 sealing portion

### BEST MODE FOR CARRYING OUT THE INVENTION

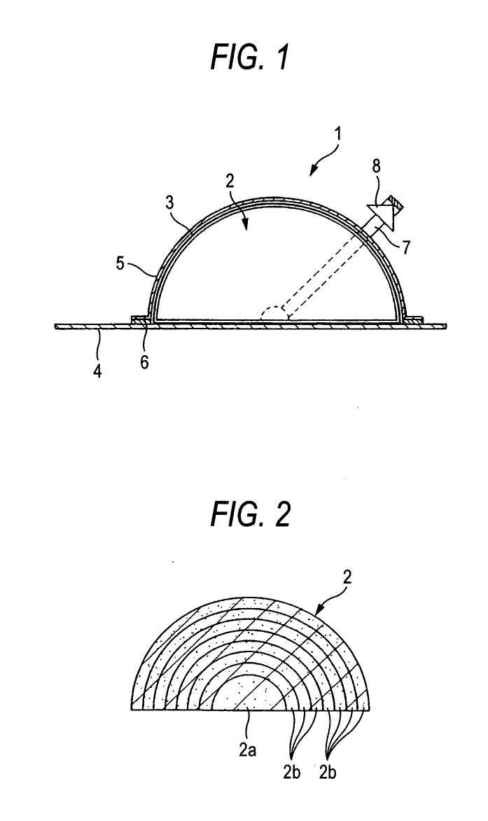

Hereinafter, a mode for carrying out a luneberg lens of the invention will be explained on the basis of accompanying drawings. A luneberg lens 1 of FIG. 1 is configured in such a manner that a lens 2 of a multi-layer structure shown in FIG. 2 is sealed by a synthetic resin film. The lens 2 is configured in such a manner that n (in the figure, n=7) pieces of different diameter hemispherical shells 2b are placed in a laminated manner, outside a hemispherical core 2a. A relative dielectric constant of a layer formed by the core 2a and n pieces of the hemispherical shells 2b varies gradually in a stepwise manner from an inside toward an outer diameter side.

At a position along a surface of this lens 2, disposed is a seal layer 3 in which a thickness is 100 μm or less, more preferably, 50 μm or less and which is formed by such a synthetic resin film that its own relative dielectric constant is higher than a relative dielectric constant of a layer of the outermost layer of the lens 2 (layer of an 8-th layer counted from an inside), and the lens 2 having this seal layer 3 is disposed on a reflecting plate 4, and an outside of the seal layer 3 is covered with a cover (radome) 5, and a gap between a flange portion of the cover 5 and the reflecting plate 4 is sealed by a seal 6.

In addition, a primary feed (LNB) 8 for receiving and transmitting radio waves from and to an arm 7 which is supported by the reflecting plate 4 is attached to configure an antenna apparatus. The primary feed 8 is kept in such a manner that its position is adjustable, and it is possible to carry out its setting at an arbitrary position of a spherical surface of a lens.

The invention is also applicable to such a spherical luneberg lens that 2 pieces of the lenses 2 shown in FIG. 2 are opposed and combined. In that spherical luneberg lens, an outside of a lens finished in a spherical shape is sealed by a synthetic resin film.

It is desirable that the synthetic resin film is a film formed by olefin series resin such as polyethylene, polypropylene and polystyrene, polyolefin series resin such as ethylene-vinyl acetate copolymer (EVA) and ethylene-acrylate copolymer (EEA), polyvinylchloride, polyvinylidene chloride, polyester, and fluorocarbon resin such as polytetrafluoroethylene, or their derivatives, or a mixture of 2 kinds or more among them, and it is more desirable if it is a shrink film. In addition, it is also all right even if a multi-layer film, in which 2 layers or more of these films are overlapped or these films are laminated each other or these films and another film (e.g., nylon) are laminated, is used. It is desirable that a thickness of a film is 100 μm or less, if possible, 50 μm or less. This is because, when it exceeds 100 μm, there appears an influence which is made on an electric performance at a region etc. where a film is overlapped, such as a film fusion-bond portion and a fold line, and in addition, when a film is too thick, it becomes something of a problem also with regard to workability.

It is desirable that the cover 5 is formed by resin which excels at weather resistance, for example, polyolefin, ABS, AES, AAS, acryl or PC(polycarbonate) or fluorocarbon resin such as PTFE. As to this cover 5, it is possible to make its thickness 2 mm or less and to reduce transmission loss of radio waves, since the seal layer 3 formed by a synthetic resin film is disposed on a surface of the lens 2.

### Embodiment 1

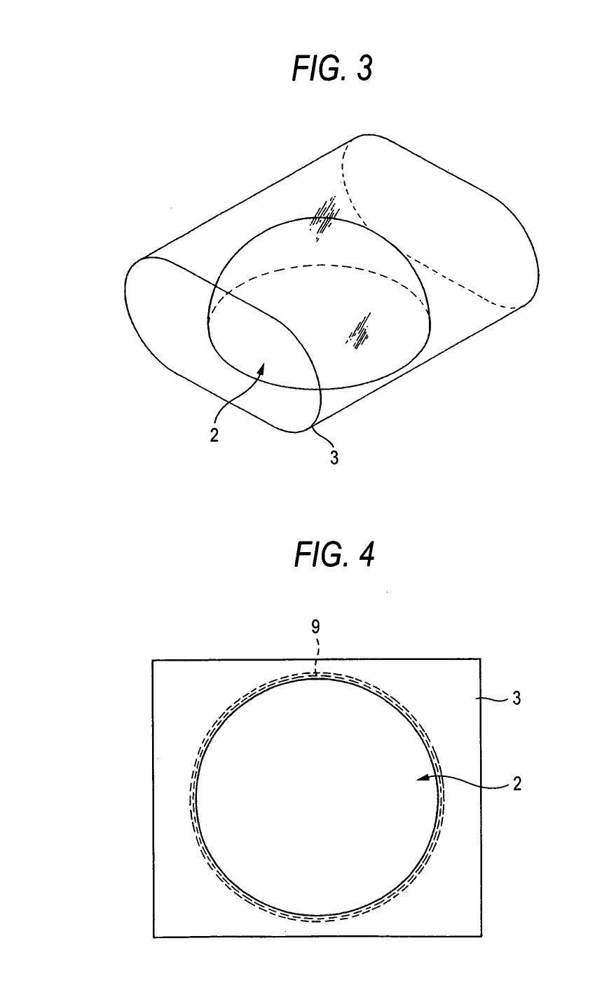

The hemispherical lens 2 of diameter 45 cm is, as shown in FIG. 3, put into a cylindrical PP shrink film 3 (fancy wrap PP PA (thickness 30 μm) made by Gunze Limited), and an upper side and a lower side of the shrink film 3 are fusion-bonded so as to draw a circle, at a place of approximately 10mm outside a flat end surface of the lens (joint surface with the reflecting plate), and sealed (9 in FIG. 4 designates a sealing portion), and a superfluous edge is cutoff. Next, at a central portion on the side of the flat end surface of the lens 2, a small hole for letting out inside air to the shrink film 3 is made by a needle, and thereafter, an entire area of the film is heated by a dryer which temperature is adjusted to approximately 100° C., and then, obtained is such a film seal type luneberg lens that the shrink film 3 is fitted closely to a surface of the lens 2.

Next, this lens is provided for a moisture prevention test, after the hole, which is used for air release, is closed. The test follows JIS C0920 security class 3 (rainproof type), and after water of 10 liter/minute is applied thereto, water droplets are wiped out cleanly, and it is placed on a reflecting plate, and gains before and after the test are measured and compared. In consequence, both of the gains before and after the test are 33.5 dB, and an influence due to water leakage is not recognized.

### COMPARATIVE EXAMPLE 1

The hemispherical lens 2 with a diameter 45 cm is provided for a moisture prevention test just as it is. In the same manner as the embodiment 1, it follows JIS C0920 security class 3 (rainproof type), and after water of 10 liter/minute is applied thereto, water droplets are wiped out cleanly, and it is placed on a reflecting plate, and gains before and after the test are measured and compared, and in consequence, a gain 33.5 dB before the test comes down to 28.6 dB after the test.

### Embodiment 2

A film sealed hemispherical luneberg lens, which is manufactured in the embodiment 1, is stored for one month at a dark place (warehouse with temperature of approximately 20° C.), and thereafter, it is disposed on a reflecting plate, and gains before and after storage are measured and compared. In consequence, both of the gains before and after the storage are 33.5 dB, and an influence due to moisture absorption is not recognized.

### COMPARATIVE EXAMPLE 2

A hemispherical luneberg lens with a diameter of 45 cm is stored for one month at a dark place (warehouse with temperature of approximately 20° C.) just as it is, and thereafter, it is disposed on a reflecting plate, and gains before and after the storage are measured and compared. In consequence, a gain 33.5 dB before the storage has become 33.3 dB after one month storage, and gain lowering of 0.2 dB is recognized.

### Embodiment 3

A hemispherical lens 2 with a diameter of 45 cm is put into a cylindrical EVA shrink film (SUNTEC S CF 100 (thickness 10 μm made by Asahi Kasei Corporation), and in the same manner as the embodiment 1, an upper side and a lower side of the shrink film are sealed so as to draw a circle, at a place of approximately 10 mm outside a two-equal-divided cross section of a sphere of a lens (joint surface with the reflecting plate), and a superfluous edge is cut off. Next, at a central portion on the side of a flat end surface of the lens 2, a small hole for letting out inside air to the shrink film is made by a needle, and thereafter, an entire area of the film is heated by a dryer which temperature is adjusted to approximately 100° C., and then, obtained is such a film seal type luneberg lens that the shrink film is fitted closely to a surface of the lens.

Next, this lens is placed on a reflecting plate, and covered with a cover which fits closely to its outside, and a gap between a flange of this cover and a reflecting plate is sealed. Then, an antenna, to which a primary feed is added, is left for approximately 3 months in an outdoor location, and gains before and after the leaving are measured and compared. In consequence, the gains before and after a test are 33.5 dB, and an influence due to water etc. is not recognized.

### COMPARATIVE EXAMPLE 3

A hemispherical luneberg lens with a diameter of 45 cm, to which a seal processing by use of a film is not applied, is placed on a reflecting plate, and covered with a cover which fits closely to its outside, and a gap between a flange of this cover and the reflecting plate is sealed. Then, an antenna, to which a primary feed is added, is left for approximately 3 months in an outdoor location, and gains before and after the leaving are measured and compared. In consequence, both of the gains before and after the leaving are 33.3 dB, and slight lowering of a performance is recognized.

### Embodiment 4

When 50 pieces of film hemispherical luneberg lenses, which are manufactured in the embodiment 1, are built into a structure of an antenna, obtained is a lens antenna in which there is no concavity and convexity, broken place, as to entire quantity.

### COMPARATIVE EXAMPLE 4

When 50 pieces of hemispherical luneberg lenses (of an identical size to that of the embodiment 4), to which seal processing by a film is not applied, are built into a structure of an antenna, concavity and convexity remain on a joint surface of a lens to a reflecting plate, as to 2 pieces, and furthermore, as to 4 pieces, on a joint surface with the reflecting plate, there is a bead missing place which is conceivable to be generated at the time of a smoothing processing work of concavity and convexity generated on that surface, and as to these things, it is apparent that it has a bad influence on a performance.

1. A luneberg lens comprising:
a lens which is configured by combining lens parts of spherical core and spherical shell-like resin foams, wherein
the lens is sealed by a synthetic resin film which is formed along a surface of the lens and in which a thickness is 100 μm or less and of which own relative dielectric constant is higher than a relative dielectric constant of the outermost layer of the lens.

2. The luneberg lens as set forth in claim 1, wherein the synthetic resin film is a shrink film.

3. An antenna apparatus comprising:
a hemispherical luneberg lens,
a reflecting plate which is attached to a two-divided cross section of a sphere of this lens,
a primary feed which is placed at a focal point portion of the lens, and
a holding unit of this primary feed, wherein
the hemispherical luneberg lens is configured by the luneberg lens set forth in claim 1.

4. An antenna apparatus comprising:
a luneberg lens of which surface is sealed by a cover made by synthetic resin,
a primary feed which is placed at a focal point portion of the lens, and
a holding unit of the primary feed, wherein
the hemispherical luneberg lens is configured by the luneberg lens as set forth in claim 1, and
the cover has a thickness of 2 mm or less.
